(19) United States
(12) Patent Application Publication
(10) Pub. No.: US 2008/0193117 A1
(43) Pub. Date: Aug. 14, 2008

(54) MOTION-DETECTING DEVICE FOR REDUCING ASSEMBLY TOLERANCE

(75) Inventors: Chia-Chu Cheng, Yonghe City (TW); Tzu-Heng Liu, Lujhou City (TW); Jau-Yu Chen, Taipei City (TW); Kun-Hsun Lee, Taipei City (TW)

Correspondence Address: RABIN & Berdo, PC, 1101 14TH STREET, NW, SUITE 500, WASHINGTON, DC, 20005, US

(73) Assignee: LITE-ON SEMICONDUCTOR CORP., Taipei Hsien (TW)

(21) Appl. No.: 12/029,684

(22) Filed: Feb. 12, 2008

(30) Foreign Application Priority Data
Feb. 12, 2007 (TW) 096202673

(51) Int. Cl. G03B 17/00

(52) U.S. Cl. 396/153

(57) ABSTRACT

A motion-detecting device for reducing assembly tolerance includes a connection unit, a light-emitting unit, an image-sensing unit and a positioning unit. The connection unit has a first fixing portion formed on one side thereof and a second fixing portion formed on another side thereof. The second fixing portion has a receiving space and a through hole communicating with the receiving space. The light-emitting unit is fixed in the first fixing portion of the connection unit for generating a projection beam. The image-sensing unit is received in the receiving space of the second fixing portion for capturing images. The positioning unit is positioned over the receiving space of the second fixing portion and electrically connected to the image-sensing unit. The transparent base is disposed under the connection unit and mated with the second fixing portion of the connection unit.

### BACKGROUND OF THE INVENTION

1. Field of the Invention

The present invention relates to a motion-detecting device, and particularly relates to motion-detecting device for reducing assembly tolerance.

2. Description of the Related Art

FIG. 1 shows a cross-sectional, schematic view of an image-sensing device of the prior art. The image-sensing device of the prior art includes a main PCB 1a, a light-emitting element 2a, an illuminant-fixing mechanism 3, an image-sensing element 4a, and a package casing 5a.

The light-emitting element 2a is fixed on the illuminant-fixing mechanism 3 and is electrically connected with the main PCB 1a via a leading wire 20a. Moreover, the image-sensing element 4a is disposed on the main PCB 1a and is electrically connected with the main PCB 1a via a plurality of leading wire 40a. Furthermore, the package casing 5a is cover on the image-sensing element 4a and has an opening hole 50a for exposing the image-sensing element 4a. Therefore, the light-emitting element 2a generates a beam Lla onto a surface d to form a reflective beam L2a, and the reflective beam L2a is projected onto the image-sensing element 4a through the opening hole 50a for sensing the image of the surface d.

However, the light-emitting element 2a and the image-sensing element 4a are separated from each other. The relationship between the light-emitting element 2a and the image-sensing element 4a needs to be adjusted accurately, so that the image-sensing element 4a can accurately sense the reflective beam L2a. Hence, the prior art is complex in manufacturing process and would produce a tolerance in assembling process. Besides, the illuminant-fixing mechanism 3 and the package casing 5a are separated from each other, so that the manufacturing cost of the prior art would be increased.

In other words, it is difficult for the light-emitting element 2a and the image-sensing element 4a to position on the main PCB 1a; alternatively, a light-guiding device (not shown) of the image-sensing device has a large assembling tolerance, so that the judgment capability of the image-sensing device would be affected.

### SUMMARY OF THE INVENTION

One particular aspect of the present invention is to provide a motion-detecting device for reducing assembly tolerance. The motion-detecting device has a connection unit, a positioning unit and a transparent base combined together in order to reduce the assembly tolerance of the motion-detecting device.

In order to achieve the above-mentioned aspects, the present invention provides a motion-detecting device for reducing assembly tolerance, including: a connection unit, a light-emitting unit, an image-sensing unit and a positioning unit. The connection unit has a first fixing portion formed on one side thereof and a second fixing portion formed on another side thereof. The second fixing portion has a receiving space and a through hole communicating with the receiving space. The light-emitting unit is fixed in the first fixing portion of the connection unit for generating a projection beam. The image-sensing unit is received in the receiving space of the second fixing portion for capturing images. The positioning unit is positioned over the receiving space of the second fixing portion and electrically connected to the image-sensing unit.

In order to achieve the above-mentioned aspects, the present invention provides a motion-detecting device for reducing assembly tolerance, including: a connection unit, a light-emitting unit, an image-sensing unit and a main PCB. The connection unit has a first fixing portion formed on one side thereof and a second fixing portion formed on another side thereof. The second fixing portion has a receiving space and a through hole communicating with the receiving space. The light-emitting unit is fixed in the first fixing portion of the connection unit for generating a projection beam. The image-sensing unit is received in the receiving space of the second fixing portion for capturing images. The image-sensing unit has a substrate and an image-sensing chip electrically disposed on the substrate. The main PCB is disposed over the substrate and electrically connected to the substrate.

Therefore, the motion-detecting device of the present invention has some advantages, as follows:

1. Because both the light-emitting unit and the image-sensing unit are fixed on the same connection unit, there is a fixed relative position between the light-emitting unit and the image-sensing unit (in the prior art, the relative position between the light-emitting element and the image-sensing element needs to be positioned anew). Hence, the present invention can reduce assembly error and increase yield rate.

2. Because the positioning unit is a datum point and the connection unit, the light-emitting unit and the image-sensing unit are fixed on the main PCB relative to the datum point together, the present invention can certify that the relative position among the positioning unit, the connection unit, the light-emitting unit and the image-sensing unit.

3. The transparent base and the connection unit are two separation elements, so that the transparent base not only can be dust-proof and anti-static, but also can be used to support and balance the connection unit.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF THE DRAWINGS

The various objects and advantages of the present invention will be more readily understood from the following detailed description when read in conjunction with the appended drawings, in which:

FIG. 1 is a cross-sectional, schematic view of an image-sensing device of the prior art;

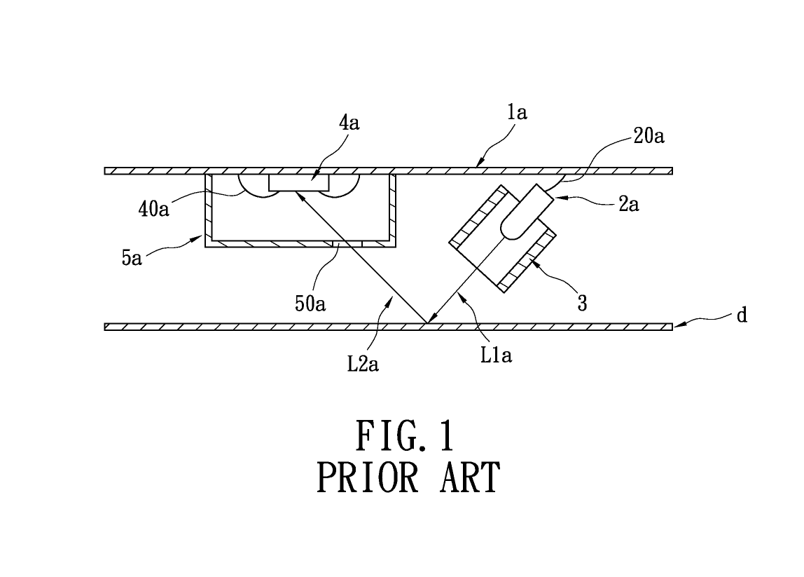

FIG. 2 is a perspective, schematic view of a motion-detecting device for reducing assembly tolerance according to the first embodiment of the present invention;

FIG. 3 is a cross-sectional, schematic view of a motion-detecting device for reducing assembly tolerance according to the first embodiment of the present invention;

FIG. 4 is a perspective, schematic view of a motion-detecting device for reducing assembly tolerance according to the second embodiment of the present invention;

FIG. 5 is a cross-sectional, schematic view of a motion-detecting device for reducing assembly tolerance according to the second embodiment of the present invention;

FIG. 6 is a perspective, schematic view of a motion-detecting device for reducing assembly tolerance according to the third embodiment of the present invention;

FIG. 7 is a cross-sectional, schematic view of a motion-detecting device for reducing assembly tolerance according to the third embodiment of the present invention;

FIG. 8 is a perspective, schematic view of a motion-detecting device for reducing assembly tolerance according to the fourth embodiment of the present invention; and

FIG. 9 is a cross-sectional, schematic view of a motion-detecting device for reducing assembly tolerance according to the fourth embodiment of the present invention.

### DETAILED DESCRIPTION OF THE PREFERRED EMBODIMENTS

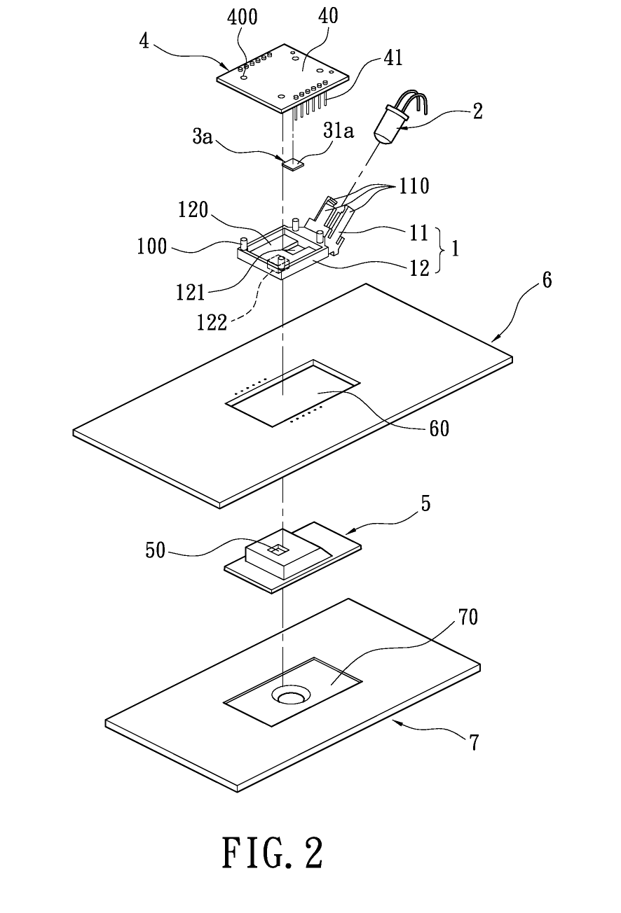

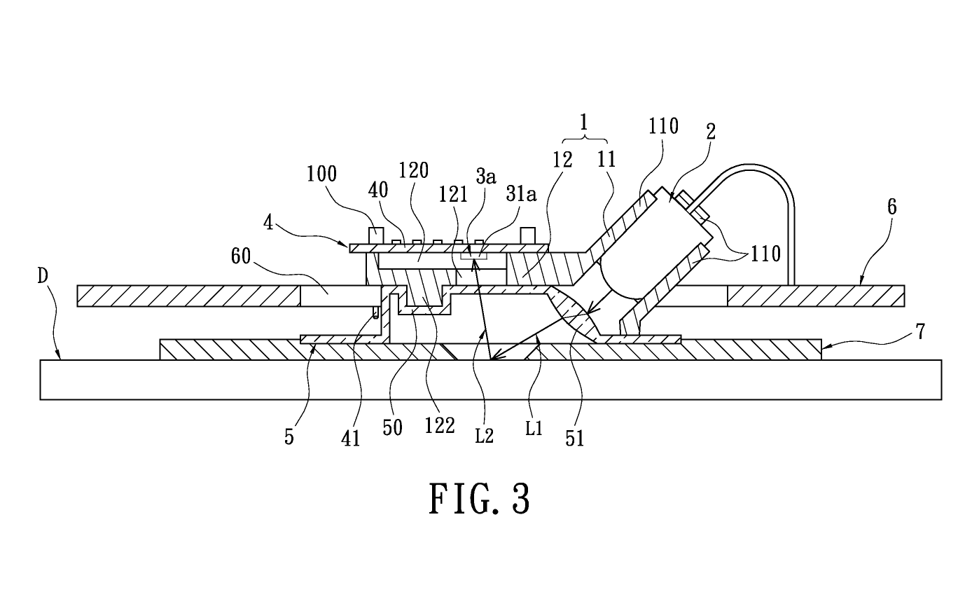

Referring to FIGS. 2 and 3, the first embodiment of the present invention provides a motion-detecting device for reducing assembly tolerance, including: a connection unit 1, a light-emitting unit 2, an image-sensing unit 3a, a positioning unit 4 and a transparent base 5.

The connection unit 1 has a first fixing portion 11 formed on one side thereof and a second fixing portion 12 formed on another side thereof. The first fixing portion 11 has four fixing pieces 110 mated with each other in order to fix the light-emitting unit 2. The second fixing portion 12 has a receiving space 120, a through hole 121 communicating with the receiving space 120 and a positioning block 122 disposed on a bottom side thereof.

Moreover, the light-emitting unit 2 is fixed in the first fixing portion 11 of the connection unit 1 for generating a projection beam L1. In addition, according to different requirements, the light-emitting unit 2 can be a laser, an LED or a resonant cavity LED.

Furthermore, the image-sensing unit 3a is an image-sensing chip 31a, and the image-sensing chip 31a is electrically disposed on the positioning unit 4. In addition, the image-sensing chip 31a is received in the receiving space 120 of the second fixing portion 12 for capturing an image of a reflective beam L2 generated by the projection beam L1 projected to a surface D.

Besides, the positioning unit 4 is an implanted pin type package structure. Hence, in the first embodiment the positioning unit 4 is composed of a PCB 40 and a plurality of pins 41 electrically connected with the PCB 40. The image-sensing chip 31a is electrically disposed on the PCB 40 via a COB (Chip On Board) package method. In addition, the PCB can be a hard PCB made of high hardness materials or a soft PCB made of plasticity materials. The positioning unit 4 is positioned over the receiving space 120 of the second fixing portion 12.

Moreover, the connection unit 1 has a plurality of first positioning elements 100, and the positioning unit 4 has a plurality of second positioning elements 400 respectively mated with the first positioning elements 100. Hence, when the first positioning elements 100 and second positioning elements 400 are mated with each other, the positioning unit 4 can be positioned over the receiving space 120 of the second fixing portion 12. In addition, each first positioning element 100 can be a positioning pin, and each second positioning element 400 can be a positioning hole or a positioning groove mated with each positioning pin. In the first embodiment, each second positioning element 400 is a positioning hole.

Furthermore, the transparent base 5 has a positioning groove 50 mated with a bottom side of the second fixing portion 12. The positioning groove 50 is used to receive the positioning block 122 of the second fixing portion 12. In other words, the transparent base 5 is disposed under the connection unit 1 and mated with the second fixing portion 12 of the connection unit 1. Hence, the transparent base 5 not only can be dust-proof and anti-static, but also can be used to support and balance the connection unit 1.

Besides, the motion-detecting device of the first embodiment further includes a main PCB 6 that has a through hole 60. The connection unit 1 passes through the through hole 60 of the main PCB 6 and the positioning unit 4 is electrically connected to and positioned on the main PCB 6 via the pins 41 in order to following image process. In addition, the motion-detecting device of the first embodiment further includes a base casing 7 for receiving the transparent base 5 in order to retain the transparent base 5 in a positioning groove 70 of the base casing 7.

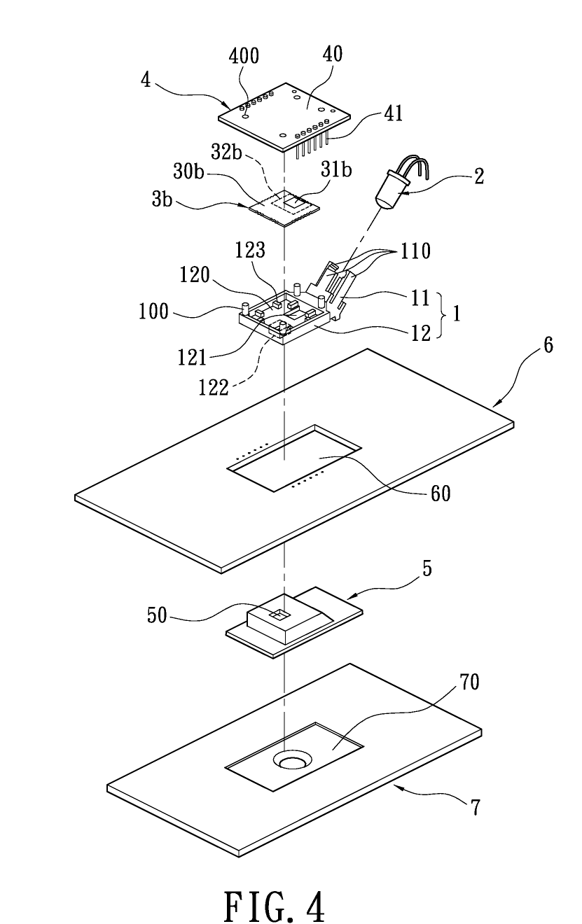

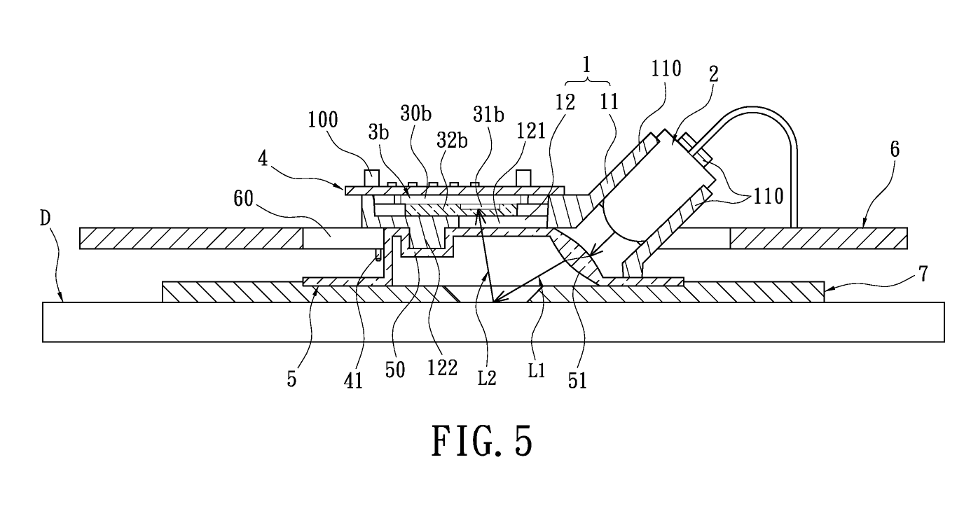

Referring to FIGS. 4 and 5, the difference between the second embodiment and the first embodiment is that: in the second embodiment, the image-sensing unit 3b has a substrate 30b, an image-sensing chip 31b electrically disposed on the substrate 30b and a package colloid 32b covering the image-sensing chip 31b.

In addition, the package colloid 32b can be an epoxy. The image-sensing unit 3b is electrically connected to the positioning unit 4 via the substrate 30b using SMT (Surface Mounted Technology). Moreover, the second fixing portion 12 of the connection unit 1 has a plurality of retaining ribs 123 inside and around the receiving space 120. Hence, the package colloid 32b is fixed by the retaining ribs 123 in order to make the image-sensing unit 3b received and positioned in the receiving space 120 of the second fixing portion 12 and capture the image of the reflective beam L2 generated by the projection beam L1 projected to the surface D.

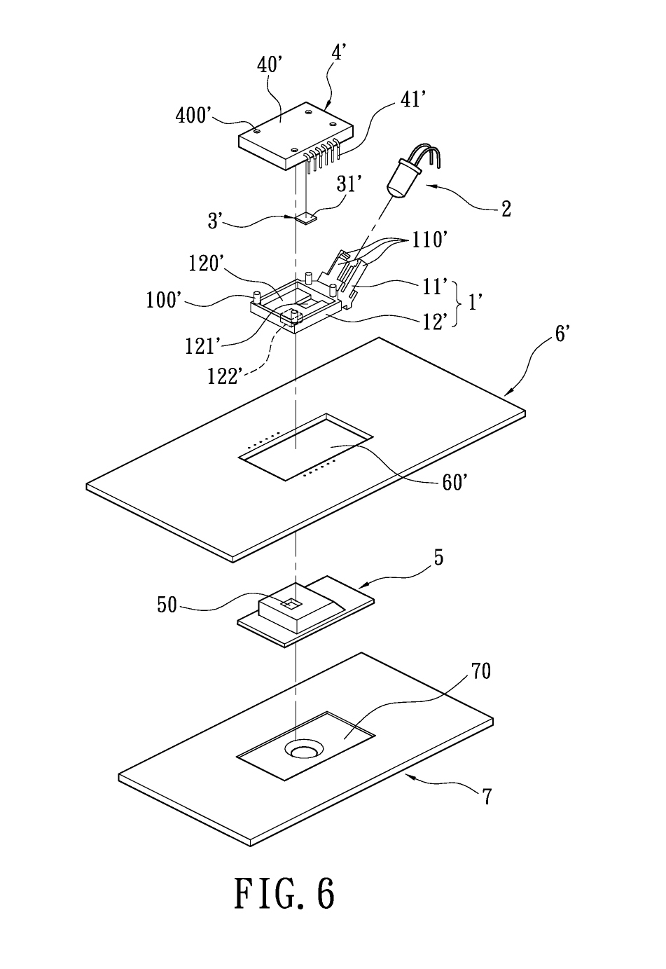

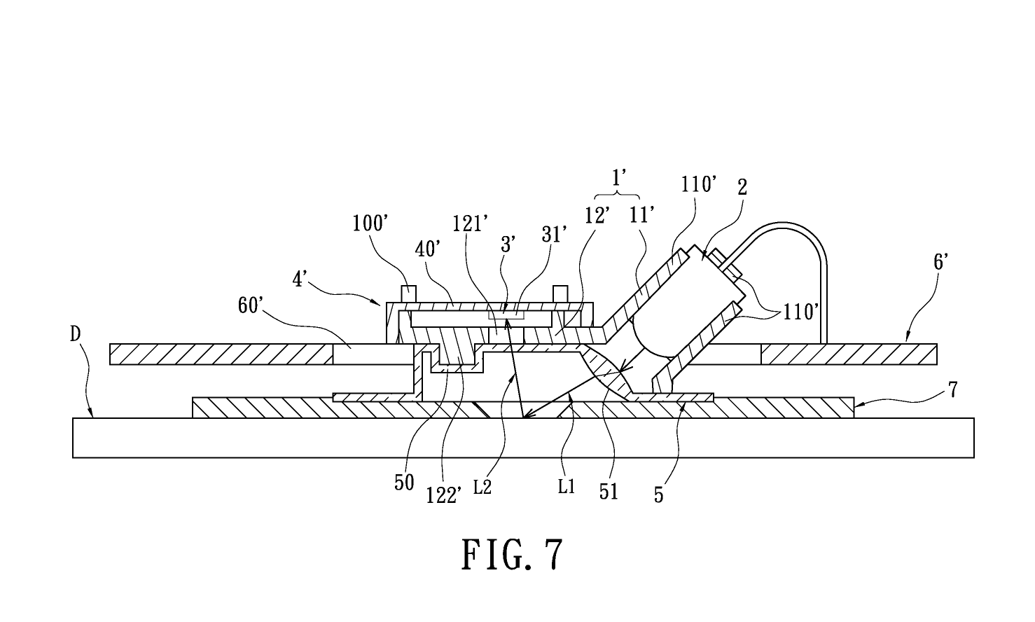

Referring to FIGS. 6 and 7, the difference between the third embodiment and the first embodiment is that: the third embodiment provides an image-sensing unit 3′ and a positioning unit 4′. The image-sensing unit 3′ is an image-sensing chip 31′ and the positioning unit 4′ is a lead frame type package structure. Hence, the positioning unit 4′ is composed of a lead frame body 40′ and a plurality of pins 41′ electrically connected with the lead frame body 40′. In addition, the image-sensing chip 31′ is electrically disposed inside the lead frame body 40′ via a COB (Chip On Board) package method in order to capture the image of the reflective beam L2 generated by the projection beam L1 projected to the surface D. Moreover, the positioning unit 4′ is electrically positioned on a main PCB 6′ via the pins 41′ and the main PCB 6′ has a through hole 60′.

Furthermore, the motion-detecting device of the third embodiment further includes a connection unit 1′ passing through the through hole 60′ of the main PCB 6′. In addition, the connection unit 1′ has a first fixing portion 11′ formed on one side thereof and a second fixing portion 12′ formed on another side thereof. The first fixing portion 11′ has four fixing pieces 110′ mated with each other in order to fix the light-emitting unit 2′. The second fixing portion 12′ has a receiving space 120′, a through hole 121′ communicating with the receiving space 120′ and a positioning block 122′ disposed on a bottom side thereof.

Moreover, the connection unit 1′ has a plurality of first positioning elements 100′, and the positioning unit 4′ has a plurality of second positioning elements 400′ respectively mated with the first positioning elements 100′. Hence, when the first positioning elements 100′ and second positioning elements 400′ are mated with each other, the positioning unit 4′ can be positioned over the receiving space 120′ of the second fixing portion 12′. In addition, each first positioning element 100′ can be a positioning pin, and each second positioning element 400′ can be a positioning hole or a positioning groove mated with each positioning pin. In the first embodiment, each second positioning element 400′ is a positioning hole.

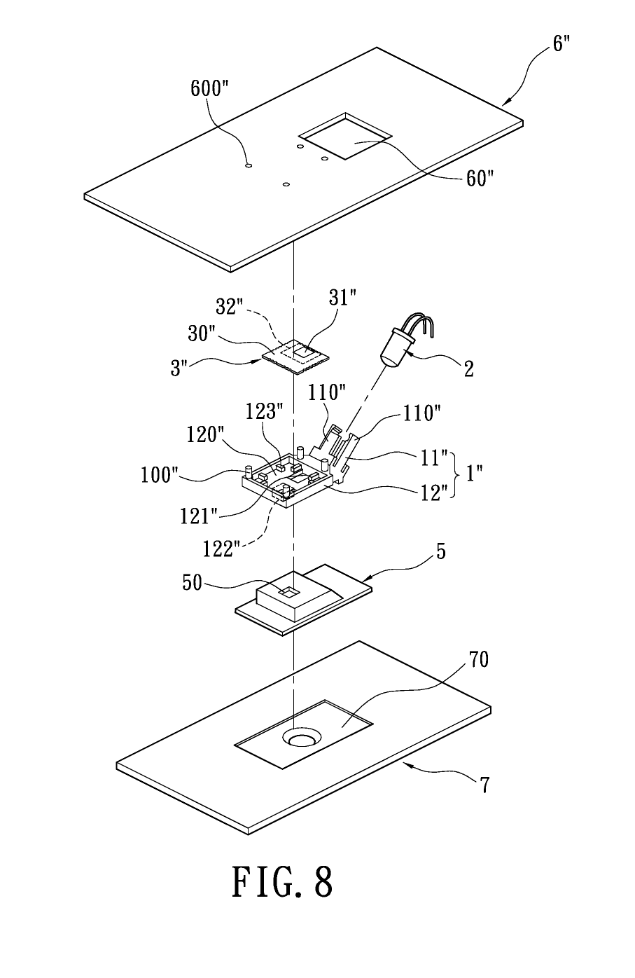

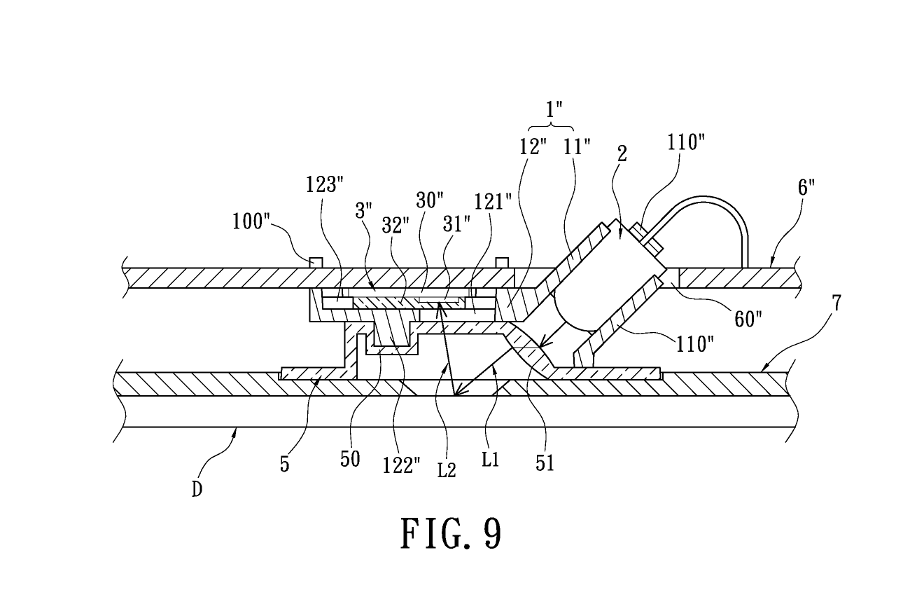

Referring to FIGS. 8 and 9, the fourth embodiment of the present invention provides a motion-detecting device for reducing assembly tolerance, including: a connection unit 1″, a light-emitting unit 2″, an image-sensing unit 3″, a main PCB 6″ and a transparent base 5″.

The connection unit 1″ has a first fixing portion 11″ formed on one side thereof and a second fixing portion 12″ formed on another side thereof. The first fixing portion 11″ has four fixing pieces 110″ mated with each other in order to fix the light-emitting unit 2″. The second fixing portion 12″ has a receiving space 120″, a through hole 121″ communicating with the receiving space 120″ and a positioning block 122″ disposed on a bottom side thereof. In addition, the second fixing portion 12″ of the connection unit 1″ has a plurality of retaining ribs 123″ inside and around the receiving space 120″.

Furthermore, the image-sensing unit 3″ has a substrate 30″, an image-sensing chip 31″ electrically disposed on the substrate 30″ and a package colloid 32″ covering the image-sensing chip 31″. In addition, the package colloid 32″ is fixed by the retaining ribs 123″ in order to make the image-sensing unit 3″ received and positioned in the receiving space 120″ of the second fixing portion 12″.

In addition, the main PCB 6″ is disposed over the substrate 30″. The main PCB 6″ is electrically connected to the substrate 30″ using SMT (Surface Mounted Technology). Moreover, the main PCB 6″ has a through hole 60″ and the connection unit 1″ passes through the through hole 60″ of the main PCB 6″.

Moreover, the connection unit 1″ has a plurality of first positioning elements 100″, and the main PCB 6″ has a plurality of second positioning elements 600″ respectively mated with the first positioning elements 100″. Hence, when the first positioning elements 100″ and second positioning elements 600″ are mated with each other, the connection unit 1″ can be positioned under the main PCB 6″. In addition, each first positioning element 100″ can be a positioning pin, and each second positioning element 600″ can be a positioning hole or a positioning groove mated with each positioning pin. In the first embodiment, each second positioning element 600″ is a positioning hole.

Furthermore, the transparent base 5 has a positioning groove 50 mated with a bottom side of the second fixing portion 12″. The positioning groove 50 is used to receive the positioning block 122″ of the second fixing portion 12″. In addition, the transparent base 5 has a collimating lens 51 for guiding the projection beam L1 generated by the light-emitting unit 2. Moreover, the motion-detecting device of the first embodiment further includes a base casing 7 for receiving the transparent base 5 in order to retain the transparent base 5 in a positioning groove 70 of the base casing 7.

In conclusion, for example in the first embodiment, the motion-detecting device of the present invention has some advantages, as follows:

1. Because both the light-emitting unit 2 and the image-sensing unit 3 are fixed on the same connection unit 1, there is a fixed relative position between the light-emitting unit 2 and the image-sensing unit 3 (in the prior art, the relative position between the light-emitting element 2a and the image-sensing element 4a needs to be positioned anew). Hence, the present invention can reduce assembly error and increase yield rate.

2. Because the positioning unit 4 is a datum point and the connection unit 1, the light-emitting unit 2 and the image-sensing unit 3 are fixed on the main PCB 6 relative to the datum point together, the present invention can certify that the relative position among the positioning unit 4, the connection unit 1, the light-emitting unit 2 and the image-sensing unit 3.

3. The transparent base 5 and the connection unit 1 are two separation elements, so that the transparent base 5 not only can be dust-proof and anti-static, but also can be used to support and balance the connection unit 1.

Although the present invention has been described with reference to the preferred best molds thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A motion-detecting device for reducing assembly tolerance, comprising:
a connection unit having a first fixing portion formed on one side thereof and a second fixing portion formed on another side thereof, wherein the second fixing portion has a receiving space and a through hole communicating with the receiving space;
a light-emitting unit fixed in the first fixing portion of the connection unit for generating a projection beam;
an image-sensing unit received in the receiving space of the second fixing portion for capturing images; and
a positioning unit positioned over the receiving space of the second fixing portion and electrically connected to the image-sensing unit.

2. The motion-detecting device as claimed in claim 1, further comprising:
a main PCB having a through hole, wherein the connection unit passes through the through hole of the main PCB and the positioning unit is electrically connected to and positioned on the main PCB.

3. The motion-detecting device as claimed in claim 1, wherein the first fixing portion of the connection unit has four fixing pieces mated with each other in order to fix the light-emitting unit.

4. The motion-detecting device as claimed in claim 1, wherein the connection unit has a plurality of first positioning elements, the positioning unit has a plurality of second positioning elements respectively mated with the first positioning elements, each first positioning element is a positioning pin, and each second positioning element is a positioning hole or a positioning groove mated with each positioning pin.

5. The motion-detecting device as claimed in claim 1, wherein the light-emitting unit is a laser, an LED or a resonant cavity LED.

6. The motion-detecting device as claimed in claim 1, wherein the image-sensing unit is an image-sensing chip, the positioning unit is a implanted pin type package structure, the positioning unit is composed of a PCB and a plurality of pins electrically connected with the PCB, and the image-sensing chip is electrically disposed on the PCB via a COB (Chip On Board) package method.

7. The motion-detecting device as claimed in claim 1, wherein the image-sensing unit is an image-sensing chip, the positioning unit is a lead frame type package structure, the positioning unit is composed of a lead frame body and a plurality of pins electrically connected with the lead frame body, and the image-sensing chip is electrically disposed inside the lead frame body via a COB (Chip On Board) package method.

8. The motion-detecting device as claimed in claim 1, wherein the image-sensing unit has a substrate, an image-sensing chip electrically disposed on the substrate and a package colloid covering the image-sensing chip, the image-sensing unit is electrically connected to the positioning unit via the substrate using SMT (Surface Mounted Technology), the package colloid is an epoxy, the second fixing portion of the connection unit has a plurality of retaining ribs inside and around the receiving space, the package colloid is fixed by the retaining ribs in order to make the image-sensing unit received and positioned in the receiving space of the second fixing portion.

9. The motion-detecting device as claimed in claim 1, further comprising: a transparent base disposed under the connection unit and mated with the second fixing portion of the connection unit.

10. The motion-detecting device as claimed in claim 9, wherein the transparent base has a collimating lens for guiding the projection beam generated by the light-emitting unit.

11. The motion-detecting device as claimed in claim 9, wherein the second fixing portion has a positioning block disposed on a bottom side thereof, and the transparent base has a positioning groove mated with the positioning block.

12. A motion-detecting device for reducing assembly tolerance, comprising:
a connection unit having a first fixing portion formed on one side thereof and a second fixing portion formed on another side thereof, wherein the second fixing portion has a receiving space and a through hole communicating with the receiving space;
a light-emitting unit fixed in the first fixing portion of the connection unit for generating a projection beam; and
an image-sensing unit received in the receiving space of the second fixing portion for capturing images.

13. The motion-detecting device as claimed in claim 12, further comprising: a main PCB having a through hole, wherein the connection unit passes through the through hole of the main PCB.

14. The motion-detecting device as claimed in claim 13, wherein the connection unit has a plurality of first positioning elements, the main PCB has a plurality of second positioning elements respectively mated with the first positioning elements, each first positioning element is a positioning pin, and each second positioning element is a positioning hole or a positioning groove mated with each positioning pin.

15. The motion-detecting device as claimed in claim 12, wherein the first fixing portion of the connection unit has four fixing pieces mated with each other in order to fix the light-emitting unit.

16. The motion-detecting device as claimed in claim 12, wherein the light-emitting unit is a laser, an LED or a resonant cavity LED.

17. The motion-detecting device as claimed in claim 13, wherein the image-sensing unit has a substrate, an image-sensing chip electrically disposed on the substrate and a package colloid covering the image-sensing chip, the image-sensing unit is electrically connected to the main PCB via the substrate using SMT (Surface Mounted Technology), the package colloid is an epoxy, the second fixing portion of the connection unit has a plurality of retaining ribs inside and around the receiving space, the package colloid is fixed by the retaining ribs in order to make the image-sensing unit received and positioned in the receiving space of the second fixing portion.

18. The motion-detecting device as claimed in claim 12, further comprising: a transparent base disposed under the connection unit and mated with the second fixing portion of the connection unit.

19. The motion-detecting device as claimed in claim 18, wherein the transparent base has a collimating lens for guiding the projection beam generated by the light-emitting unit.

20. The motion-detecting device as claimed in claim 18, wherein the transparent base has a positioning groove mated with a bottom side of the second fixing portion.
